(19) United States
(12) Patent Application Publication
(10) Pub. No.: US 2023/0067898 A1
(43) Pub. Date: Mar. 2, 2023

(54) DRIVE APPARATUS

(71) Applicant: NIDEC CORPORATION, Kyoto (JP)

(72) Inventors: Kentaro OKI, Kyoto (JP); Shuhei NAKAMATSU, Kyoto (JP)

(21) Appl. No.: 17/893,185

(22) Filed: Aug. 23, 2022

(30) Foreign Application Priority Data
Aug. 24, 2021 (JP) 2021-136487

(51) Int. Cl. F16H 57/04; H02K 9/19

(52) U.S. Cl. CPC F16H 57/0475; F16H 57/043; F16H 57/045; F16H 57/0421; F16H 57/0424; F16H 57/0436; F16H 57/0457; H02K 9/19; F16H 2057/02034

(57) ABSTRACT

A motor having a motor shaft rotatable about a motor axis; a power transmission having gears and connected to the motor shaft; a housing having a motor housing portion accommodating the motor and a gear accommodation portion accommodating the power transmission; a fluid contained in the housing; and a fluid channel through which the fluid flows, in which a reservoir storing the fluid above the motor axis is provided in the inside of the gear accommodation portion. The fluid channel includes an external supply channel for supplying the fluid from an outside of the motor to the motor, and an internal supply channel for supplying the fluid to a hollow portion of the motor shaft. The reservoir has a first supply port and a second supply port. The external supply channel is connected to a first supply port. The internal supply channel is connected to a second supply port.

### CROSS-REFERENCE TO RELATED APPLICATIONS

The present invention claims priority under 35 U.S.C. §119 to Japanese Patent Application No. 2021-136487 filed on Aug. 24, 2021, the entire content of which is incorporated herein by reference.

### FIELD OF THE INVENTION

The present invention relates to a drive apparatus.

### BACKGROUND

In recent years, with the spread of electric vehicles and hybrid vehicles, the development of drive apparatuses for driving vehicles has been advanced. In such a drive apparatus, a fluid such as oil is stored therein in order to enhance lubricity of the gear or to cool the rotary electric machine. In a conventional configuration, oil scraped up by a gear is stored in an oil reservoir and further supplied to an electric motor by a guide pipe.

In the conventional structure, a fluid in a reservoir called an oil reservoir is externally supplied to a motor to cool the motor. In such a configuration, the fluid hardly reaches the inside of the motor, and there is a possibility that the inside of the motor cannot be sufficiently cooled.

### SUMMARY

One aspect of an exemplary drive apparatus of the present invention includes: a motor having a motor shaft that rotates about a motor axis; a power transmission mechanism having a plurality of gears and connected to the motor shaft; a housing having a motor housing portion that houses the motor therein and a gear accommodation portion that houses the power transmission mechanism therein; a fluid contained in the housing; and a fluid channel through which the fluid flows, in which a reservoir that stores the fluid above the motor axis is provided in the inside of the gear accommodation portion. The fluid channel includes an external supply channel for supplying the fluid from an outside of the motor to the motor, and an internal supply channel for supplying the fluid to a hollow portion of the motor shaft. The reservoir has a first supply port and a second supply port. The external supply channel is connected to a first supply port. The internal supply channel is connected to a second supply port.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a schematic view of a drive apparatus 1 according to a first embodiment;

FIG. 2 is a schematic view illustrating a first configuration of a first supply port and a second supply port that can be employed as a reservoir of the first embodiment;

FIG. 3 is a schematic view illustrating a second configuration of a first supply port and a second supply port that can be adopted as a reservoir of the first embodiment;

FIG. 4 is a schematic view illustrating a third configuration of a first supply port and a second supply port that can be adopted as a reservoir of the first embodiment;

FIG. 5 is a schematic view of a drive apparatus according to a second embodiment; and

FIG. 6 is a schematic view of a drive apparatus according to a third embodiment.

### DETAILED DESCRIPTION

A drive apparatus according to an embodiment of the present invention will be described below with reference to the drawings.

In the following description, the vertical direction is defined and described based on the positional relationship when a drive apparatus of an embodiment illustrated in each drawing is mounted on a vehicle located on a horizontal road surface. In the accompanying drawings, an XYZ coordinate system is shown appropriately as a three-dimensional orthogonal coordinate system. In the XYZ coordinate system, a Z-axis direction is the vertical direction. A +Z side is an upper side in the vertical direction, and a -Z side is a lower side in the vertical direction. In the following description, the upper side and the lower side in the vertical direction will be referred to simply as the “upper side” and the “lower side”, respectively. An X-axis direction is a direction orthogonal to the Z-axis direction and is a front-rear direction of a vehicle on which a drive apparatus is mounted. In the embodiment below, a +X side is a front side of a vehicle, and a -X side is a rear side of the vehicle. A Y-axis direction is a direction orthogonal to both the X-axis direction and the Z-axis direction, and is a left-right direction of the vehicle, that is, a vehicle width direction. In the following embodiment, a +Y side is a left side of the vehicle, and a -Y side is a right side of the vehicle. The front-rear direction and the right-left direction are horizontal directions orthogonal to the vertical direction.

A motor axis J2 illustrated appropriately in the drawings extends in the Y-axis direction, i.e., the left-right direction of the vehicle. In the following description, unless otherwise specified, a direction parallel to the motor axis J2 is simply referred to as an “axial direction”, a radial direction centered on the motor axis J2 is simply referred to as a “radial direction”, and a circumferential direction centered on the motor axis J2, that is, around the motor axis J2 is simply referred to as a “circumferential direction”. In the following description, the +Y side may be simply referred to as one side in the axial direction, and the -Y side may be simply referred to as the other side in the axial direction.

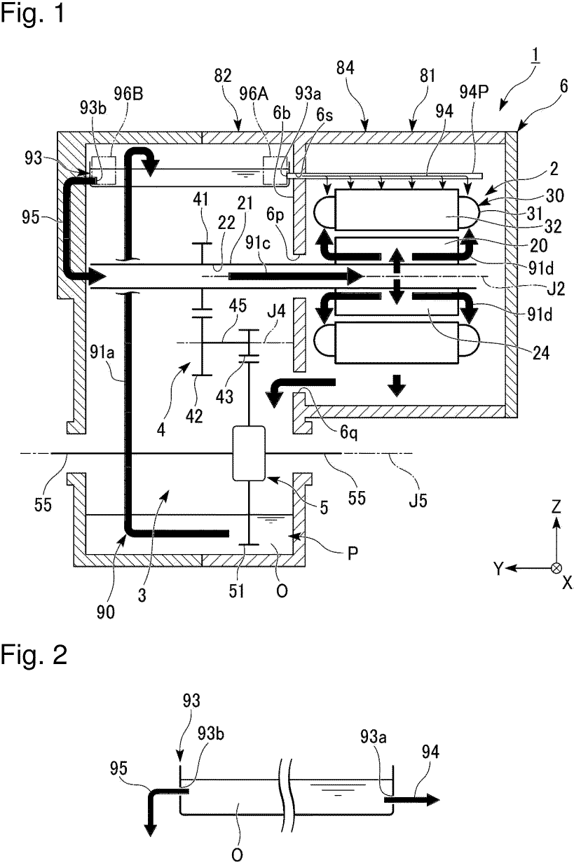

FIG. 1 is a schematic view of a drive apparatus 1 according to a first embodiment.

The drive apparatus 1 is mounted on a vehicle using a motor as a power source, such as a hybrid vehicle (HEV), a plug-in hybrid vehicle (PHV), or an electric vehicle (EV), and is used as the power source.

The drive apparatus 1 includes a motor 2, a power transmission mechanism 3, a housing 6, a fluid O contained in the inside of the housing 6, and a fluid channel 90 through which the fluid O flows.

The housing 6 includes a motor housing portion 81 that houses the motor 2 therein and a gear accommodation portion 82 that houses the power transmission mechanism 3 therein. The housing 6 has a partition 6b that partitions the internal space of the motor housing portion 81 and the internal space of the gear accommodation portion 82. The gear accommodation portion 82 is located on one side (+Y side) in the axial direction of the motor housing portion 81.

The partition 6b is provided with a supply pipe passing hole 6s, a shaft passing hole 6p, and a partition opening 6q. The supply pipe passing hole 6s, the shaft passing hole 6p, and the partition opening 6q allow the internal spaces of the motor housing portion 81 and the gear accommodation portion 82 to communicate with each other.

A reservoir 93 is provided in the inside of the gear accommodation portion 82. The reservoir 93 opens upward to store the fluid O. The reservoir 93 is located above the motor axis J2. That is, the reservoir 93 stores the fluid O above the motor axis J2. Here, storing the fluid O above the motor axis J2 means that the lower end of the storage space in which the fluid O is stored is located above the motor axis J2.

The reservoir 93 is, for example, a gutter member protruding from the inner side face of the gear accommodation portion 82. In this case, the reservoir 93 is a part of the housing 6. The reservoir 93 may be a member separate from the housing 6.

The fluid O is contained in the inside of the housing 6. The fluid O circulates in the fluid channel 90 described later. In the present embodiment, the fluid O is oil, and is used not only for cooling the motor 2 but also for lubricating the power transmission mechanism 3. An oil equivalent to an automatic transmission fluid (ATF) having a relatively low viscosity is preferably used as the fluid O so that the oil can perform functions of a lubricating oil and a cooling oil.

A fluid reservoir P in which the fluid O is accumulated is provided in the lower region in the gear accommodation portion 82. The fluid O accumulated in the fluid reservoir P is scraped up by the operation of the power transmission mechanism 3 and diffused into the gear accommodation portion 82. The fluid O diffused in the gear accommodation portion 82 spreads over the tooth surfaces of the power transmission mechanism 3 and is used for lubrication of the power transmission mechanism 3.

The fluid O in the fluid reservoir P is scraped up by the operation of the power transmission mechanism 3 and supplied to the reservoir 93. The fluid O stored in the reservoir 93 is sent to the inside of the motor housing portion 81 in the fluid channel 90 to cool the motor 2.

The housing 6 is preferably provided with a cooler (not illustrated) that cools the fluid O in the fluid channel 90. As a result, the motor 2 can be efficiently cooled via the fluid O. The cooler is provided, for example, in the fluid reservoir P. It may be provided in the reservoir 93.

In the present embodiment, the motor 2 is an inner-rotor motor. The motor 2 of the present embodiment is, for example, a three-phase AC motor. The motor 2 has both a function as an electric motor and a function as a generator. The motor 2 includes a motor shaft 21, a rotor 20, and a stator 30.

The motor shaft 21 extends along the axial direction about the motor axis J2. The motor shaft 21 rotates about the motor axis J2. The motor shaft 21 is a hollow shaft in which a hollow portion 22 is provided.

The motor shaft 21 passes through the shaft passing hole 6p of the partition 6b. The motor shaft 21 extends across the motor housing portion 81 and the gear accommodation portion 82 of the housing 6. The motor shaft 21 is connected to the rotor 20 in the inside of the motor housing portion 81. The motor shaft 21 is connected to the power transmission mechanism 3 in the inside of the gear accommodation portion 82. That is, the power transmission mechanism 3 is connected to the motor shaft 21 from one side (+Y side) in the axial direction. The motor shaft 21 is rotatably supported by the housing 6 via a bearing (not illustrated).

The rotor 20 is fixed to the outer peripheral face of the motor shaft 21 in the inside of the motor housing portion 81. The rotor 20 is rotatable about the motor axis J2 extending in the horizontal direction. The rotor 20 includes a rotor core 24 and a rotor magnet (not illustrated) fixed to the rotor core. The torque of the rotor 20 is transmitted to the power transmission mechanism 3.

The stator 30 encloses the rotor 20 from radially outside. The stator 30 has a stator core 32, a coil 31, and an insulator (not illustrated) interposed between the stator core 32 and the coil 31. The stator 30 is held by the housing 6. The stator core 32 has a plurality of magnetic pole teeth (not illustrated) radially inward from an inner peripheral face of an annular yoke. A coil wire is disposed between the magnetic pole teeth. The coil wire located in the gap between the adjacent magnetic pole teeth constitutes the coil 31. The insulator is made of an insulating material.

The power transmission mechanism 3 includes a plurality of gears 41, 42, 43, and 51. The power transmission mechanism 3 is connected to the rotor 20 of the motor 2 to transmit power. The power transmission mechanism 3 includes a reduction gear 4 and a differential device 5.

The reduction gear 4 has a function of increasing the torque output from the motor 2 in accordance with a reduction ratio by reducing rotation speed of the motor 2. The reduction gear 4 is connected to the motor shaft 21. The reduction gear 4 transmits the torque outputted from the motor 2 to the differential device 5.

The reduction gear 4 includes a pinion gear 41, an intermediate shaft 45, and a counter gear 42 and a drive gear 43 fixed to the intermediate shaft 45. The torque output from the motor 2 is transmitted to the ring gear 51 of the differential device 5 via the motor shaft 21, the pinion gear 41, the counter gear 42, and the drive gear 43 of the motor 2. The number of gears, the gear ratios of the gears, and so on can be modified in various manners in accordance with a desired reduction ratio.

The pinion gear 41 is fixed to the outer peripheral face of the motor shaft 21 of the motor 2. The pinion gear 41 rotates about the motor axis J2 together with the motor shaft 21.

The intermediate shaft 45 extends along an intermediate axis J4 parallel to the motor axis J2. The intermediate shaft 45 rotates about the intermediate axis J4.

The counter gear 42 and the drive gear 43 are arranged side by side in the axial direction. The counter gear 42 and the drive gear 43 are provided on the outer peripheral face of the intermediate shaft 45. The counter gear 42 and the drive gear 43 are connected via the intermediate shaft 45. The counter gear 42 and the drive gear 43 rotate about the intermediate axis J4. At least two of the counter gear 42, the drive gear 43, and the intermediate shaft 45 may be formed of a single member. The counter gear 42 meshes with the pinion gear 41. The drive gear 43 meshes with the ring gear 51 of the differential device 5.

The differential device 5 is a device arranged to transfer the torque outputted from the motor 2 to wheels of the vehicle. The differential device 5 has a function of transferring the torque to the pair of output shaft 55 while absorbing a difference in speed between the left and right wheels when the vehicle is turning.

The differential device 5 includes the ring gear (scraping gear) 51, a gear housing (not illustrated), a pair of pinion gears (not illustrated), a pinion shaft (not illustrated), and a pair of side gears (not illustrated). The ring gear 51 rotates about a differential axis J5 parallel to the motor axis J2. The torque outputted from the motor 2 is transferred to the ring gear 51 through the reduction gear 4.

The pair of output shafts 55 extends along the axial direction. A side gear is connected to one end of each of the pair of output shafts 55, and a wheel is connected to the other end. The pair of output shafts 55 transmits the torque of the motor 2 to the road surface via the wheels.

In the present embodiment, the ring gear 51 has a larger diameter than that of other gears. At least a part of the ring gear 51 is immersed in the fluid reservoir P. Therefore, the power transmission mechanism 3 scraps up the fluid O in the fluid reservoir P at the time of driving in the ring gear 51. Part of the fluid O scraped up by the ring gear 51 is supplied to the reservoir 93. That is, the power transmission mechanism 3 transfers the fluid O from the fluid reservoir P to the reservoir 93.

The fluid O circulates in the fluid channel 90 in the drive apparatus 1. The fluid channel 90 is a channel for supplying the fluid O from the fluid reservoir P to the motor 2 and returning the fluid O to the fluid reservoir P again.

In the present specification, the “fluid channel” means a channel of the fluid O circulating in the housing 6. Therefore, the “fluid channel” is a concept including not only a “flow passage” that constantly forms a steady fluid flow in one direction but also a channel (for example, a reservoir) for temporarily retaining the fluid, a channel in which the fluid drips, and a channel in which the fluid is scattered.

The fluid channel 90 is provided with the reservoir 93 and a supply pipe 94P. The reservoir 93 is disposed in the upper region in the gear accommodation portion 82. The reservoir 93 receives and stores the fluid O scraped up by the power transmission mechanism 3. The supply pipe 94P is connected to a first supply port 93a of the reservoir 93. Note that the supply pipe 94P and the reservoir 93 may not be directly connected, and may be connected via a separate member. The supply pipe 94P extends along the axial direction. The supply pipe 94P passes through the supply pipe passing hole 6s of the partition 6b. The supply pipe 94P extends across the motor housing portion 81 and the gear accommodation portion 82. The supply pipe 94P is disposed on the upper side of the motor 2 in the inside of the motor housing portion 81. The supply pipe 94P is provided with an injection hole opened to the motor 2 side.

The fluid channel 90 of the present embodiment includes a scraping channel 91a, an external supply channel 94, an internal supply channel 95, an intra-shaft channel 91c, and an intra-rotor channel 91d.

The scraping channel 91a is a channel that scraps up the fluid O by the rotation of the gear (the ring gear 51 in the present embodiment) of the power transmission mechanism 3 and guides the fluid O to the reservoir 93. By transferring the fluid O from the fluid reservoir P to the reservoir 93 by the scraping channel 91a, the storage amount of the reservoir 93 increases, and the liquid level of the fluid O in the fluid reservoir P decreases. According to the present embodiment, by storing the fluid O in the reservoir 93, it is possible to lower the liquid level of the fluid reservoir P and reduce the stirring resistance of the power transmission mechanism 3 by the fluid O.

The reservoir 93 has the first supply port 93a and a second supply port 93b. The first supply port 93a and the second supply port 93b are through holes provided in the side wall of the reservoir 93. The first supply port 93a and the second supply port 93b may be notches provided in the side wall of the reservoir 93 and opened upward, and may be through holes provided in the bottom wall of the reservoir 93. The fluid O stored in the reservoir 93 flows out of the reservoir 93 via the first supply port 93a and the second supply port 93b.

The external supply channel 94 is connected to the first supply port 93a of the reservoir 93, and the internal supply channel 95 is connected to the second supply port 93b. The fluid channel 90 branches downstream of the reservoir 93 into the external supply channel 94 and the internal supply channel 95.

The external supply channel 94 is a channel for supplying the fluid O in the reservoir 93 from the outside of the motor 2 to the motor 2. The external supply channel 94 extends in the axial direction in the inside of the supply pipe 94P. The supply pipe 94P of the present embodiment is, for example, a pipe. That is, the external supply channel 94 is a channel passing through the pipe. The external supply channel 94 extends in the axial direction directly above the motor 2 in the inside of the motor housing portion 81. The fluid O passing through the external supply channel 94 is injected from an injection hole provided in the supply pipe 94P toward the motor 2.

In addition, in this specification, “directly above” means that they are disposed so as to overlap each other as viewed from above and the up-down direction.

The fluid O supplied from the outside to the motor 2 by the external supply channel 94 takes heat from the stator 30 at the time of transmitting the surface of the stator 30, and cools the stator 30. Further, the fluid O drops from the stator 30, reaches the lower region in the motor housing portion 81, and returns to the fluid reservoir P via the partition opening 6q.

The internal supply channel 95 is a channel for supplying the fluid O from the reservoir 93 to the hollow portion 22 of the motor shaft 21. The internal supply channel 95 connects the second supply port 93b of the reservoir 93 and an opening on one side (+Y side) in the axial direction of the motor shaft 21.

The internal supply channel 95 is a hole provided in the housing 6. The internal supply channel 95 is formed by drilling a wall portion of the housing 6. Therefore, it is not necessary to separately provide a piping member between the reservoir 93 and the end portion on one side (+Y side) in the axial direction of the motor shaft 21, and an increase in the number of parts can be suppressed.

The intra-shaft channel 91c is a channel through which the fluid O passes in the hollow portion 22 of the motor shaft 21. In the intra-shaft channel 91c, the fluid O flows from one side (+Y side) in the axial direction toward the other side (-Y side) in the axial direction.

The intra-rotor channel 91d is a channel that passes through the inside of the rotor core 24 and scatters the fluid O to the stator 30. When passing through the intra-rotor channel 91d, the fluid O takes heat from the rotor 20 and cools the rotor 20. A centrifugal force accompanying the rotation of the rotor 20 is applied to the fluid O passing through the intra-shaft channel 91c. The fluid O passes radially outward through the intra-rotor channel 91d, is scattered radially outward from the rotor 20, and is supplied to the stator 30. The fluid O supplied from the radially inner side to the stator 30 via the internal supply channel 95, the intra-shaft channel 91c, and the intra-rotor channel 91d takes heat from the stator 30 when flowing along the surface of the stator 30, and cools the stator 30 from the inner side.

In the fluid channel 90 of the present embodiment, the fluid O that branches on the downstream side of the reservoir 93 and passes through the external supply channel 94 and the internal supply channel 95 is supplied to the motor 2 from the inside and the outside, drips to the lower side of the motor 2, and joins in the lower region in the motor housing portion 81.

According to the present embodiment, part of the fluid O stored in the reservoir 93 cools the motor 2 from the outside via the external supply channel 94, and the other part cools the motor 2 from the inside via the internal supply channel 95. That is, according to the present embodiment, the cooling efficiency of the motor 2 can be enhanced by cooling the inside and outside of the motor 2 via the reservoir 93.

According to the present embodiment, the reservoir 93 is disposed above the motor axis J2. Therefore, the reservoir 93 supplies the fluid O stored using gravity to the external supply channel 94 and the internal supply channel 95. That is, according to the present embodiment, since the fluid O is supplied to the inside and the outside of the motor 2 via the reservoir 93 above the motor axis J2, the fluid O can be supplied to the motor 2 without using a pump and with low power consumption even if used.

In the fluid channel 90 of the present embodiment, the fluid O is stored in the reservoir 93 and then supplied to the motor 2. According to the present embodiment, since the fluid O supplied to the motor 2 is stored in the reservoir 93 on the upstream side of the motor 2, it is easy to lower the liquid level of the fluid O in the fluid reservoir P. Therefore, the stirring resistance of the gear by the power transmission mechanism 3 can be suppressed.

The fluid channel 90 of the present embodiment transfers the fluid O from the fluid reservoir P to the reservoir 93 by the scraping channel 91a. Therefore, it is not necessary to provide a pump or the like in the fluid channel 90, and an inexpensive drive apparatus can be provided.

As illustrated in FIG. 1, the drive apparatus 1 of the present embodiment may include one or both of pumps (second pumps) 96A, 96B provided in a passage of fluid channel 90. The pumps 96A and 96B are electric pumps driven by electricity.

The pump 96A is disposed at the first supply port 93a of the reservoir 93. The pump 96A pumps the fluid O stored in the reservoir 93 into the external supply channel 94.

The other pump 96B is disposed in the second supply port 93b of the reservoir 93. The pump 96B pumps the fluid O stored in the reservoir 93 into the internal supply channel 95.

The fluid O is supplied from the reservoir 93 to at least one of the external supply channel 94 and the internal supply channel 95 by the pumps 96A and 96B. According to this configuration, the flow rate of the fluid O supplied from the inside of the reservoir 93 to the external supply channel 94 or the internal supply channel 95 can be adjusted. As a result, it is possible to effectively cool the motor 2 by adjusting the supply amount of the fluid O to one or both of the inside and the outside of the motor 2 according to the heat generation state of the motor 2.

The external supply channel 94 of the present embodiment passes through the pipe. Therefore, by pumping the fluid O to the external supply channel 94 using the pump 96A, the pressure of the fluid O in the external supply channel 94 can be increased, and the fluid O can be ejected to the motor 2. As a result, the fluid O can reach the complicated portion of the motor 2 to efficiently cool the motor 2.

FIGS. 2 to 4 are schematic views illustrating first to third configurations of the first supply port 93a and the second supply port 93b that can be adopted as the reservoir 93 of the present embodiment. Any one of the first to third configurations can be adopted as the reservoir 93 of the present embodiment.

The first supply port 93a and the second supply port 93b of the first to third configurations have different positional relationships in the vertical direction. Here, the vertical positions of the first supply port 93a and the second supply port 93b strictly mean the vertical positions obtained by comparing the lower end positions of the first supply port 93a and the second supply port 93b.

In the first configuration illustrated in FIG. 2, the first supply port 93a is located below the second supply port 93b. That is, in this configuration, the lower end of the first supply port 93a is located below the lower end of the second supply port 93b. Therefore, when the liquid level in the reservoir 93 gradually decreases, the supply of the fluid O from the second supply port 93b is stopped, and then the supply of the fluid O from the first supply port 93a is stopped. According to this configuration, even when the liquid level in the reservoir 93 drops, the supply of the fluid O to the outside of the motor 2 via the external supply channel 94 is easily maintained. Therefore, this configuration is adopted when it is desired to increase the cooling efficiency on the outer side of the motor 2 as compared with the cooling efficiency on the inner side.

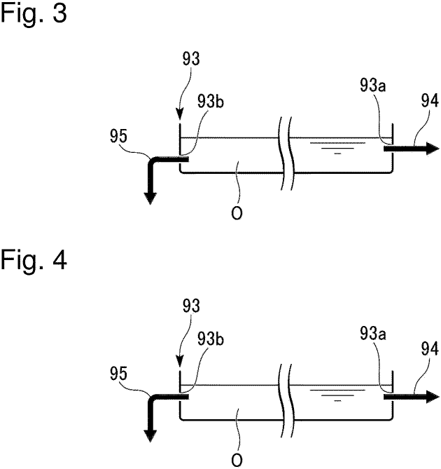

In the second configuration illustrated in FIG. 3, the second supply port 93b is located below the first supply port 93a. That is, in this configuration, the lower end of the second supply port 93b is located below the lower end of the first supply port 93a. Therefore, when the liquid level in the reservoir 93 gradually decreases, the supply of the fluid O from the first supply port 93a is stopped, and then the supply of the fluid O from the second supply port 93b is stopped. According to this configuration, even when the liquid level in the reservoir 93 drops, the supply of the fluid O to the inside of the motor 2 via the internal supply channel 95 is easily maintained. Therefore, this configuration is adopted when it is desired to increase the cooling efficiency inside the motor 2 as compared with the cooling efficiency outside the motor 2.

In the third configuration illustrated in FIG. 4, the first supply port 93a and the second supply port 93b are arranged at the same height. That is, in this configuration, the lower end of the first supply port 93a and the lower end of the second supply port 93b are arranged at the same height. Therefore, when the liquid level in the reservoir 93 gradually decreases, the fluid O supplied from the first supply port 93a and the second supply port 93b stops substantially simultaneously. According to this configuration, the fluid O can be supplied to the inside and the outside of the motor 2 in a well-balanced manner.

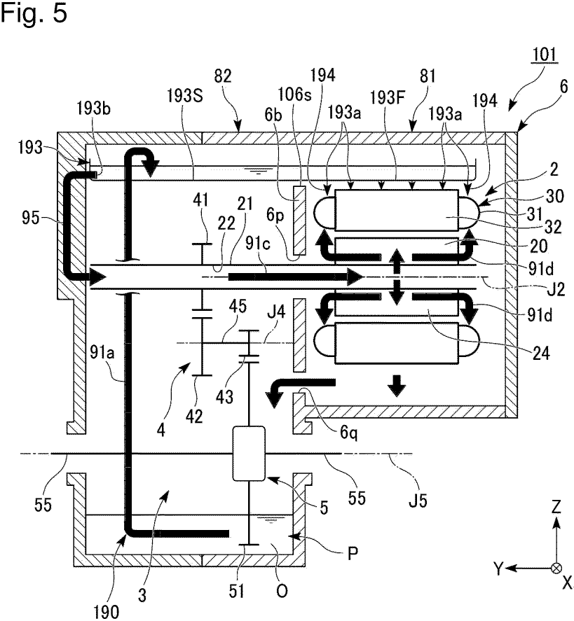

FIG. 5 is a schematic view of a drive apparatus 101 according to a second embodiment.

The drive apparatus 101 of the present embodiment is different from that of the first embodiment mainly in the configurations of a reservoir 193 and an external supply channel 194.

In the description of each embodiment to be described below, the same reference numerals are given to the same components as those of the embodiment already described, and the description thereof will be omitted.

In the present embodiment, the reservoir 193 is a gutter member extending along the axial direction. In the present embodiment, a reservoir passing hole 106s is provided in the partition 6b of the housing 6. The reservoir 193 is provided across the motor housing portion 81 and the gear accommodation portion 82 through the reservoir passing hole 106s.

The reservoir 193 has a first portion 193F disposed in the motor housing portion 81 and a second portion 193S disposed in the gear accommodation portion 82. The reservoir 193 is disposed on the upper side of the motor 2 in the first portion 193F, and is disposed on the upper side of the power transmission mechanism 3 in the second portion 193S.

The reservoir 193 opens upward at least at the second portion 193S. The reservoir 193 receives and stores the fluid O scraped up by the power transmission mechanism 3 in the second portion 193S. As described above, part of the fluid O received by the second portion 193S flows to the first portion 193F side. Part of the fluid O is transferred from the gear accommodation portion 82 to the motor housing portion 81 by being stored in the reservoir 193.

As in the above-described embodiment, the reservoir 193 has a first supply port 193a and a second supply port 193b. The first supply port 193a is connected to the external supply channel 194 for supplying the fluid O from the outside of the motor 2 to the motor 2. The second supply port 193b is connected to the internal supply channel 95 that supplies the fluid O to the hollow portion 22 of the motor shaft 21.

The external supply channel 194 of the present embodiment is a through hole provided in the bottom wall of the first portion 193F of the reservoir 193. The external supply channel 194 may be a through hole or a notch provided in a side wall of the reservoir 193. That is, the external supply channel 194 may be provided on the side wall or the bottom wall of the reservoir 193. The external supply channel 194 opens directly above the motor 2. The first supply port 193a of the present embodiment is an opening portion on the upper side of the through hole constituting the external supply channel 194. Similarly to the above-described embodiment, the external supply channel 194 is connected to the first supply port 193a, and supplies the fluid O from the outside of the motor 2 to the motor 2.

In the fluid channel 190 of the present embodiment, the fluid O is supplied from the fluid reservoir P to the reservoir 193 via the scraping channel 91a. The fluid channel 190 branches downstream of the reservoir 193, one of which is supplied to the outside of the motor 2 via an external supply channel 194 and the other to the hollow portion 22 of the motor shaft 21 via an internal supply channel 95. According to the present embodiment, similarly to the above-described embodiment, the motor 2 can be efficiently cooled from the inside and the outside.

The drive apparatus 101 of the second embodiment may include the pumps 96A and 96B similar to those of the first embodiment (see FIG. 1). In the reservoir 193 of the second embodiment, the first supply port 193a and the second supply port 193b may be arranged in any positional relationship of the first to third configurations (FIGS. 2 to 3) as in the first embodiment.

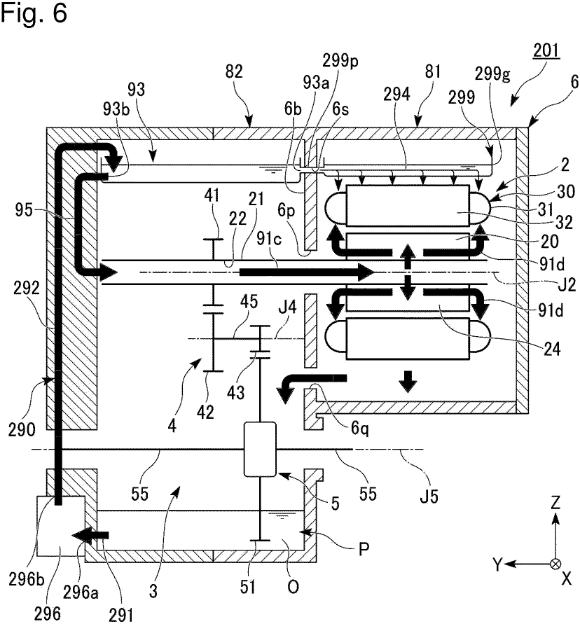

FIG. 6 is a schematic view of a drive apparatus 201 according to a third embodiment.

The drive apparatus 201 of the present embodiment is different from that of the first embodiment mainly in the configurations of a fluid channel 290 and an external supply channel 294.

The drive apparatus 201 of the present embodiment includes a pump (first pump) 296. The pump 296 is fixed to the outer side face of the gear accommodation portion 82. The pump 296 is provided in the path of the fluid channel 290. The pump 296 pumps the fluid O in the path of the fluid channel 290. The pump 296 may be an electric pump that is electrically driven or a mechanical pump that operates in accordance with the drive of the power transmission mechanism 3. The pump 296 has a suction port 296a and a discharge port 296b. The fluid O is sucked into the pump 296 from the suction port 296a and discharged from the discharge port 296b.

The fluid channel 290 of the present embodiment includes the first flow passage 291 and the second flow passage 292 for supplying the fluid O in the fluid reservoir P to the reservoir 93. The first flow passage 291 connects the fluid reservoir P and the suction port 296a of the pump 296. The second flow passage 292 connects the discharge port 296b of the pump 296 and the reservoir 93. The first flow passage 291 and the second flow passage 292 are holes provided in the housing 6. The first flow passage 291 and the second flow passage 292 are formed by drilling a wall portion of the housing 6.

According to the present embodiment, the fluid O is supplied from the fluid reservoir P to the reservoir 93 by the pump 296. According to the present embodiment, it is possible to secure the storage amount of the fluid O in the reservoir 93 regardless of the operation of the power transmission mechanism 3. Therefore, regardless of the operation of the power transmission mechanism 3, the fluid O can be supplied to the inside and the outside of the motor 2 via the reservoir 93, and the motor 2 can be efficiently cooled even when the power transmission mechanism 3 is not operating or the operation is low speed.

A supplying gutter 299 is provided in the inside of the motor housing portion 81 of the housing 6 of the present embodiment. That is, the drive apparatus 201 of the present embodiment includes the supplying gutter 299. The supplying gutter 299 has a gutter body 299g and a pipe portion 299p.

The gutter body 299g is disposed in the inside of the motor housing portion 81. The gutter body 299g extends along the axial direction. The gutter body 299g is located directly above the motor 2. A through hole for supplying the fluid O to the motor 2 is provided in the bottom portion of the gutter body 299g.

The pipe portion 299p extends from a side wall on one side (+Y side) in the axial direction of the gutter body 299g to the one side in the axial direction. The pipe portion 299p passes through the supply pipe passing hole 6s of the partition 6b. The pipe portion 299p is connected to the first supply port 93a of the reservoir 93 in the inside of the motor housing portion 81.

The external supply channel 294 of the present embodiment extends in the supplying gutter 299 from the first supply port 93a of the reservoir 93. That is, the external supply channel 294 passes through the inside of the gutter. The external supply channel 294 extends in the axial direction directly above the motor 2 in the inside of the motor housing portion 81. The fluid O passing through the external supply channel 294 is dropped from the through hole at the bottom portion of the supplying gutter 299 toward the motor 2.

In the present embodiment, the fluid O in the external supply channel 294 is supplied to the motor 2 by being dropped after being stored in the supplying gutter 299. Therefore, according to the external supply channel 294 of the present embodiment, even when the supply of the fluid O from the fluid reservoir P to the reservoir 93 is stopped, the fluid O stored in the supplying gutter 299 can be supplied to the motor 2 little by little for a long time.

Although the case where the external supply channel 294 passes through the inside of the gutter in the fluid channel 290 of the present embodiment has been described, the external supply channel may pass through the inside of the pipe as in the first embodiment. Conversely, the external supply channel 94 may pass through the inside of the gutter in the fluid channel 90 of the first embodiment.

The drive apparatus 201 of the third embodiment may include the pumps 96A and 96B similar to those of the first embodiment (see FIG. 1). In the reservoir 93 of the third embodiment, the first supply port 93a and the second supply port 93b may be arranged in any positional relationship of the first to third configurations (FIGS. 2 and 3) as in the first embodiment.

In addition, instead of a supply pipe 94P and supplying gutter 299, a cavity may be provided inside the side wall of the motor housing potion 81. That is, the external supply channel is a channel passing through the cavity. The cavity extends inside the side wall of the motor housing portion 81 in the axial direction. The cavity is located above the motor 2. The cavity is connected to the reservoir 93 directly or indirectly. The side wall has at least one injection hole opened to the motor 2 side. The fluid O passing through the external supply channel is injected from the injection hole provided in side wall toward the motor 2.

While an embodiment of the present invention and modifications thereof have been described above, it will be understood that features, a combination of the features, and so on according to the embodiment are only illustrative, and that an addition, elimination, and substitution of a feature(s), and other modifications can be made without departing from the scope and spirit of the present invention. Also note that the present invention is not limited by the embodiment. Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A drive apparatus comprising:
a motor having a motor shaft that rotates about a motor axis;
a power transmission mechanism having a plurality of gears and connected to the motor shaft;
a housing having a motor housing portion that houses the motor therein and a gear accommodation portion that houses the power transmission mechanism therein;
a fluid contained in an inside of the housing; and
a fluid channel through which the fluid flows, wherein
a reservoir that stores the fluid above the motor axis is provided in an inside of the gear accommodation portion,
the fluid channel includes:
an external supply channel that supplies the fluid from an outside of the motor to the motor; and
an internal supply channel configured to supply the fluid to a hollow portion of the motor shaft,
the reservoir has a first supply port and a second supply port,
the external supply channel is connected to a first supply port, and
the internal supply channel is connected to a second supply port.

2. The drive apparatus according to claim 1, wherein the first supply port is located below the second supply port.

3. The drive apparatus according to claim 1, wherein the second supply port is located below the first supply port.

4. The drive apparatus according to claim 1, wherein the first supply port and the second supply port are disposed at a same height.

5. The drive apparatus according to claim 1, wherein
the reservoir is provided across between the gear accommodation portion and the motor housing portion, and
the external supply channel is provided on a side wall or a bottom wall of the reservoir.

6. The drive apparatus according to claim 1, wherein
a fluid reservoir in which the fluid is accumulated is provided in a lower region of the gear accommodation portion, and
the fluid channel has a scraping channel for scraping up the fluid by rotation of the gear and guiding the fluid to the reservoir.

7. The drive apparatus according to claim 1, comprising
a first pump provided in a path of the fluid channel, wherein
a fluid reservoir in which the fluid is accumulated is provided in a lower region of the gear accommodation portion, and
the fluid is supplied from the fluid reservoir to the reservoir by the first pump.

8. The drive apparatus according to claim 1, comprising
a second pump provided in a path of the fluid channel, wherein
the fluid is supplied from the reservoir to at least one of the external supply channel and the internal supply channel by the second pump.

9. The drive apparatus according to claim 1, wherein the external supply channel passes through a pipe.

10. The drive apparatus according to claim 1, wherein the external supply channel passes through a gutter.
